(19) United States
(12) Patent Application Publication
(10) Pub. No.: US 2005/0235536 A1
(43) Pub. Date: Oct. 27, 2005

(54) Apparatus for use with a door or doorway

(75) Inventor: Stuart Harris, London (GB)

Correspondence Address: COHEN, PONTANI, LIEBERMAN & PAVANE, Suite 1210, 551 Fifth Avenue, New York, NY, 10176, US

(73) Assignee: Spin Master Ltd.

(21) Appl. No.: 11/087,978

(22) Filed: Mar. 23, 2005

(30) Foreign Application Priority Data
Mar. 25, 2004 (GB) 0406717.9

(51) Int. Cl. G09F 15/00; G09F 15/02

(52) U.S. Cl. 40/606.07

(57) ABSTRACT

An apparatus for use on or adjacent to a doorway, door or window. The apparatus includes a mounting for location proximate the top of a doorway or window opening. The mounting has a fastener for downwardly suspending articles from the mounting. The apparatus includes an adjustable mounting bracket for affixing the apparatus to different sizes of doorways.

The invention to which this application relates is apparatus which can be used to enhance or change the appearance of a door or doorway or window. Typically, although not necessarily exclusively, the apparatus is provided to be used in conjunction with a door, doorway or window to give an appearance that is particularly attractive to children.

The provision of wall hangings and structures for use within a room is well known in order to change the appearance of the same so as to make the room visually appealing to a child. The changes could for example be to give the room the appearance of a castle, a cave, a jungle environment, a princess's room or the like.

A problem with this known apparatus is that it is all provided for use within a room and therefore until the child enters into the room, there is no visual indication externally of the room of changes which may be made in the room or, furthermore, there is no provision for the changing of the appearance of an entry into a room or other area.

The aim of the present invention is to provide apparatus which can be used to alter the appearance of a conventional doorway and/or door itself in a manner whereby the selective application of the apparatus allows a particular themed visual appearance to be achieved.

In a first aspect of the invention there is provided apparatus for use on or adjacent to a doorway, said apparatus comprising a mounting for location at or adjacent to the top of the doorway, said mounting having location means to allow articles to be suspended from the mounting and depend downwardly from the mounting, said mounting located on the doorway frame or wall surrounding the same by at least one mounting bracket with the bracket(s) and/or mounting selectively positionable so as to allow fitment to different sizes of doorway.

In one embodiment, the mounting bracket is located within the mounting in slots and the mounting brackets are movable along said slots so as to allow the adjustment of the position of the same with regard to the mounting.

Typically the arm of the mounting bracket is located within the mounting body and therefore hidden from view when attached to the doorway frame or adjacent wall.

In one embodiment the mounting is formed of a series of layers a front layer, back layer and intermediate layer, with the intermediate layer typically including a recess depending upwardly from each of the slots so as to receive the bracket arm.

In one embodiment the mounting is further covered by fabric or other sheet material to form the external faces of the same.

In an alternative embodiment or as an additional fitment to the apparatus there is provided a bar which is telescopically adjustable so as to allow the length of the bar to be adjusted to suit fitment to a particular doorway size. In one embodiment the bar is locatable with the mounting brackets via a loop located over an arm of the bracket.

The article or articles which depend from the mounting can be any of items of fabric, plastic, board, beads or any combination of the same with the article designed so as to give a particular external appearance for the doorway.

The articles which depend from the mounting are typically shaped and/or positioned with respect to the mounting so that the door is still openable and not obstructed by the apparatus. While the size of the doorway itself may, although preferably will not, be restricted by the provision of the apparatus as herein described, it will be appreciated that the restriction will not be sufficient so as to block the doorway for access.

It should be appreciated that the invention as herein described, can also be used in conjunction with a window or window frame with the same characteristics and features applicable.

In a further aspect of the invention, there is provided apparatus for attachment to a door or wall surface, said apparatus including attachment means and, on an external face thereof, an area defined for writing or drawing thereon, said area having a surface which allows the application and subsequent removal of the writing or drawing applied thereto.

In one embodiment, the area for writing or drawing is a blackboard or white board surface and the writing or drawing applied thereto is removed by suitable wiping means.

In an alternative embodiment, the area for applying the writing or drawing includes a series of magnetic particles located behind a front surface and the writing or drawing applied thereto can be removed by movement of a member with respect to the said surface.

In a further embodiment the apparatus can include a number of activity indicators and a means allowing selection of one of said activities and providing a visual indication of said selection.

Typically, the apparatus is provided to have an appearance which is linked to a particular environment, licensed character or the like and in one embodiment can be used in conjunction with the apparatus of the first aspect of the invention.

Specific embodiments of the invention will now be described with reference to the accompanying drawings, wherein:

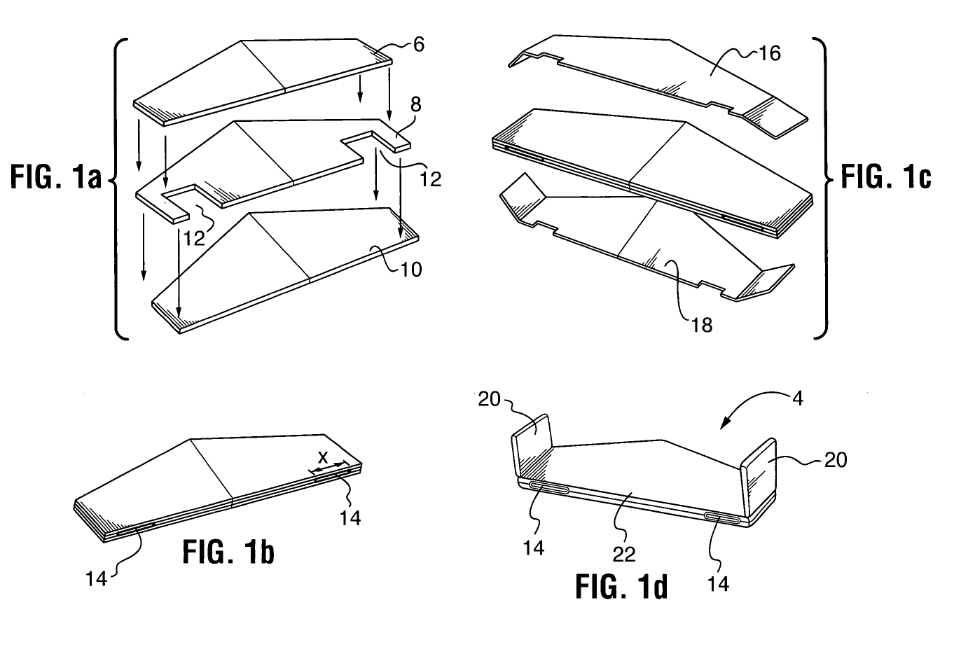

FIG. 1a-d illustrate the components of the mounting of the apparatus in a first embodiment of the invention;

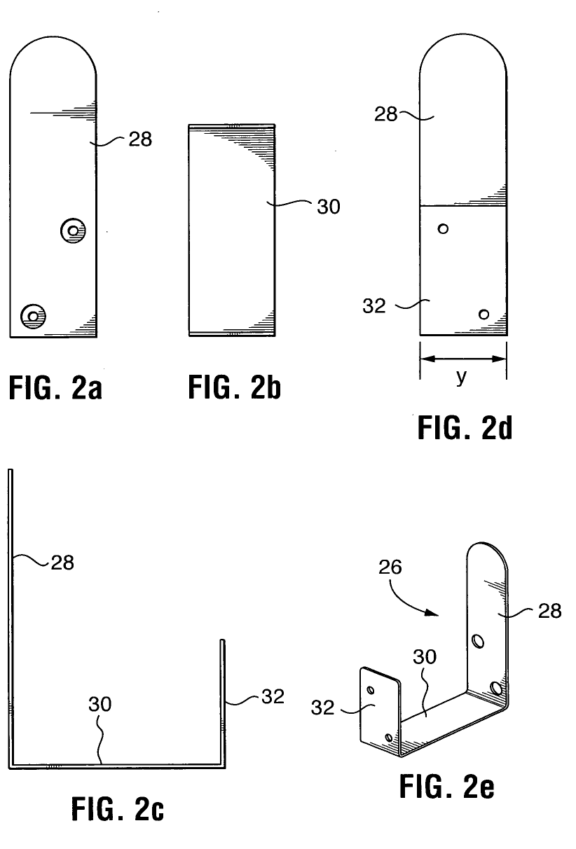

FIGS. 2a-e illustrate views of the mounting bracket which can be used in the first and second embodiment of the invention;

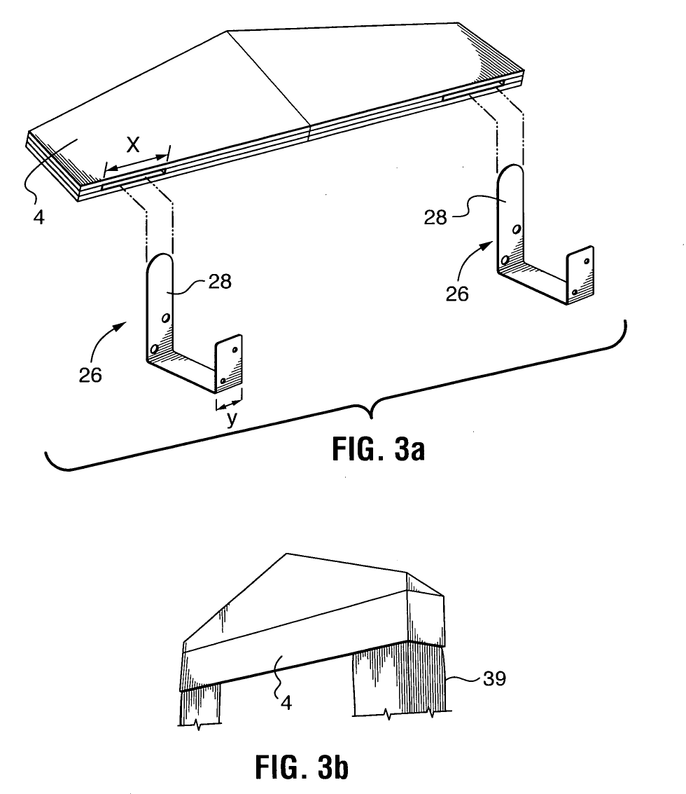

FIG. 3a-b illustrate the components of FIGS. 1 and 2 in use in combination to locate the mounting in position in the first embodiment illustrates the components of FIG. 1 in an engaged position;

FIG. 3 illustrates apparatus in accordance with a first aspect of the invention fitted to a doorway;

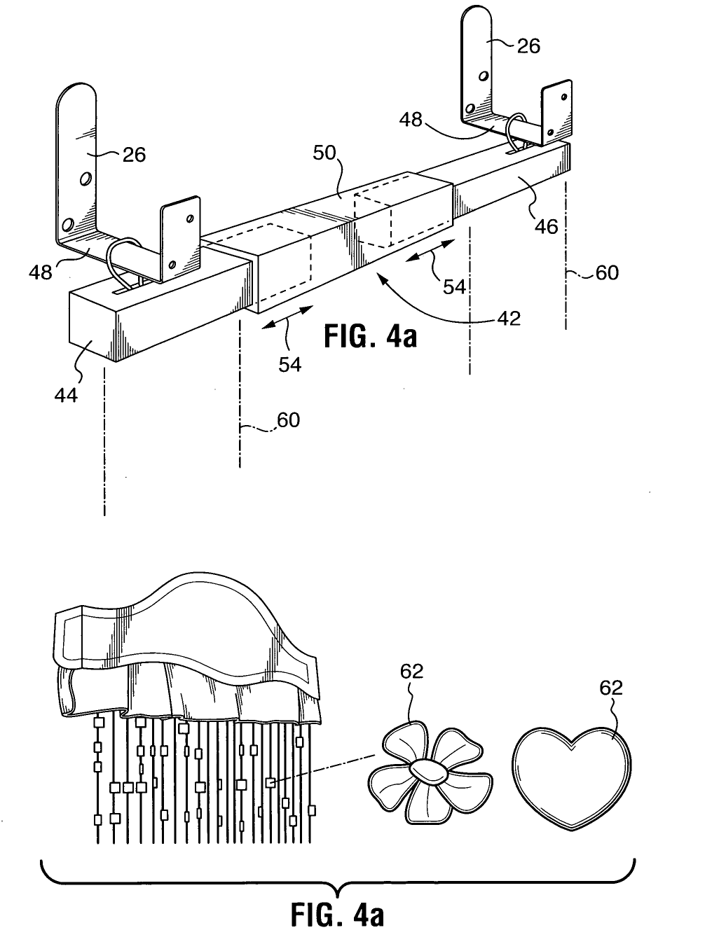

FIGS. 4a and b illustrate a further embodiment of the apparatus in accordance with the first aspect of the invention;

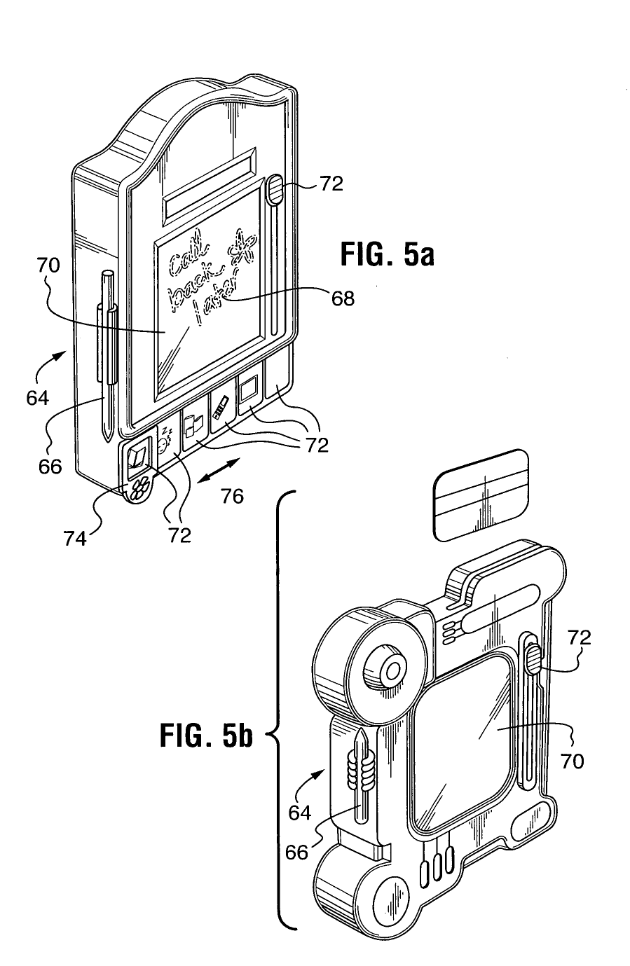

FIGS. 5a and b illustrate two embodiments of the second aspect of the invention; and

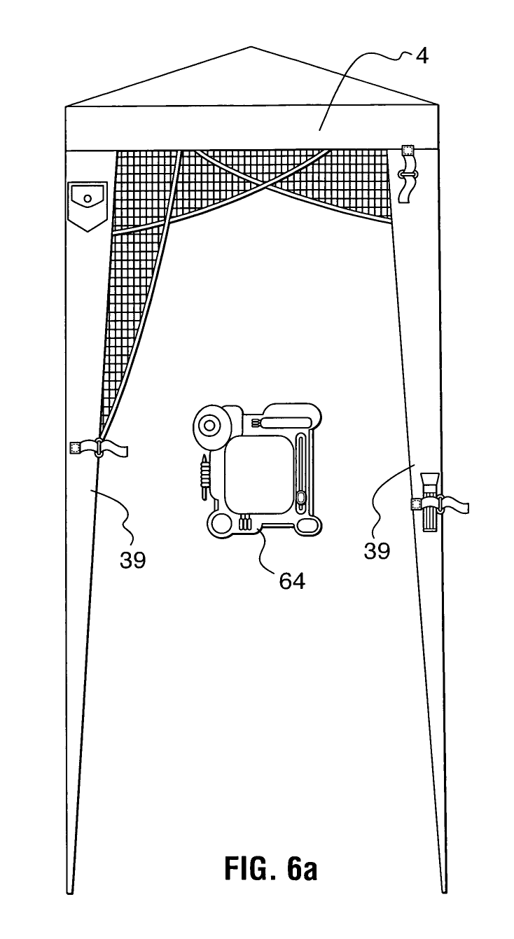

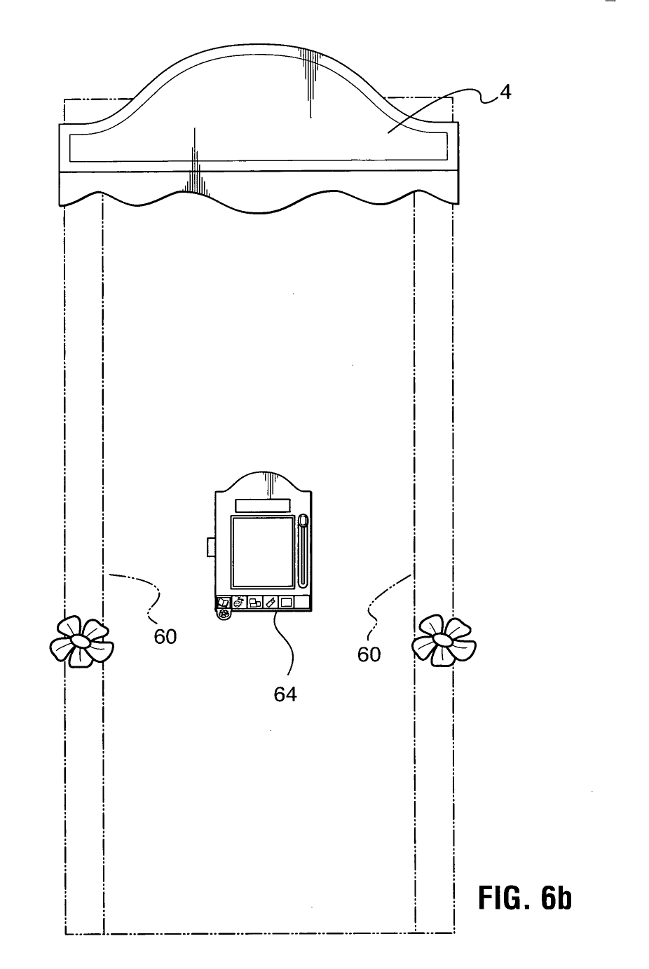

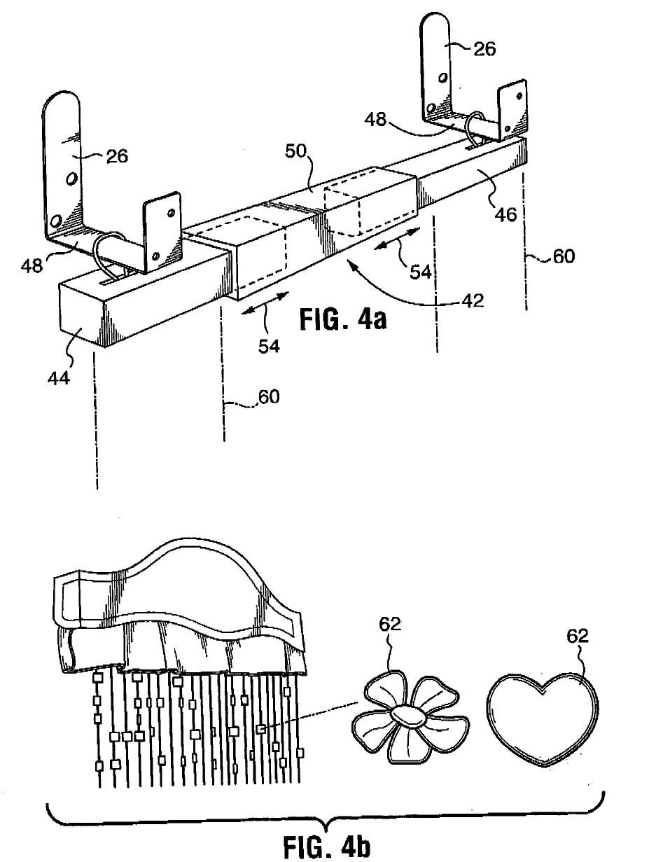

FIGS. 6a-b illustrate the apparatus of the first and second aspects used in conjunction.

Referring firstly to FIGS. 1, 2 and 3, there is illustrated the components of apparatus 2 in accordance with a first aspect of the invention. In FIGS. 1a-d there is illustrated the formation of the mounting 4 from three layers 6,8,10, with the intermediate layer having recesses 12 formed therein. When joined as shown in FIG. 1b, the recesses form slots 14. Outer layers 16, 18, typically of fabric or some other form of sheet material are joined to the core as shown in FIG. 1c to form the outer faces of the mounting 4. Flange portions 20 can be provided to offset the front 22 from the doorway.

FIGS. 2a-e illustrate the mounting bracket 26 which comprises a first elongate arm 28 which is received in the slot 14 of the mounting and secured thereto. A spacer limb 30 is provided which leads to the arm 32 which is provided to be secured to the doorway frame or wall.

The position of the bracket with respect to the slot 14 can be adjusted as the width X of the slot is greater than the width Y of the bracket as illustrated in FIG. 3a. This therefore means that the apparatus can be adjusted to allow fitment of the same to doorways of varying width by selective adjustment of the brackets with respect to the slots 14.

The arms 28 of the mounting bracket are hidden within the mounting when the same is applied to the doorway and therefore are not externally viewable as is illustrated in FIG. 3b with articles in the form of fabric 39.

FIGS. 4a and b illustrate a further possible component of the apparatus of FIGS. 1-3. This comprises a bar 42 formed from first and second members 44, 46 which are provided with location means 48 for location on the brackets 26. A third member 50 is provided which slidingly engages with members 44, 46 to form the bar so as to allow the length of the bar to be adjusted by sliding of the members as shown by arrows 54.

Also provided to be suspended from the bar are a series of articles 60 which can for example be threaded with a series of beads 62 and provide the effect shown in FIG. 4b in conjunction with the apparatus mounting as shown in FIGS. 1-3 where the appearance of the apparatus, in this case, is of an entry to a princess's room with articles depending downwardly from the mounting so as to mask the normal appearance of the doorway and furthermore, provide an imaginary view to the doorway.

FIGS. 5a and b illustrate a further aspect of the invention which is typically provided for attachment to the door, doorway or to the wall adjacent to the doorway. The apparatus 64 has a visual appearance which is again linked to a particular feature such as a princess's room or licensed character or the like, and includes an area 70 which is provided to allow the selective writing or drawing thereon. For example, a child can use appropriate drawing instrument 66 to leave a message 68 on the same and/or provide a drawing. In this example the area 70 is of a construction which involves magnetic particles being used to form the message in conjunction with the movement of the instrument 66 and then being cleared by the movement of a member 72 with respect to the construction. In FIG. 5a there is shown the provision of visual representation 72 of a series of possible activities and an indicator 74 which is movable as indicated by arrow 76 to be locatable on a particular activity icon 72 to indicate the activity of that person at that time.

The apparatus as herein described is particularly effective when used in combination and FIGS. 6a and b illustrate two possible combinations where the visual effect created is particularly strong.

When one considers that the appearance of the apparatus can be linked with the appearance of a room entered via the doorway, it will be appreciated that a strong visual appearance can be created.

It will therefore be appreciated that the invention as herein described allows significant advantage in changing the appearance of a doorway and door to provide an improved visual appearance to the same without the need to undertake expensive and time consuming redecoration. Furthermore, by allowing the relatively temporary change in appearance of the door or doorway so any changes which are made need not be permanent and so changes in requirements or preferences of a child can be readily accommodated with relatively little expense.

1. Apparatus for use on or adjacent to a doorway, said apparatus comprising a mounting for location at or adjacent to the top of the doorway, said mounting having location means to allow articles to be suspended from the mounting and depend downwardly from the mounting, said mounting located on the doorway frame or wall surrounding the same by at least one mounting bracket with the bracket(s), mounting, or both selectively positionable so as to allow fitment to different sizes of doorway.

2. Apparatus as claimed in claim 1, wherein the mounting bracket is located within the mounting in slots and the mounting brackets are movable along said slots so as to allow the adjustment of the position of the same with regard to the mounting.

3. Apparatus as claimed in claim 2, wherein said mounting bracket is located within the mounting body whereby it is hidden from view when attached to the doorway frame or adjacent wall.

4. Apparatus as claimed in claim 2, wherein said mounting is formed of a series of layers including a front layer, back layer and intermediate layer, said intermediate layer including a recess depending upwardly from each of the slots so as to receive said bracket arm.

5. Apparatus as claimed in claim 4, wherein said mounting is further covered by fabric or other sheet material thereby defining the external faces of the same.

6. Apparatus as claimed in claim 1, wherein there is provided a bar, said bar being telescopically adjustable to allow the length of the bar to be adjusted to the dimensions of a selected doorway.

7. Apparatus as claimed in claim 6, wherein said bar is locatable with the mounting brackets via a loop located over an arm the bracket.

8. Apparatus as claimed in claim 6, wherein the article or articles which depend from the mounting are items of fabric, plastic, board, beads or any combination of the same, designed so as to give a particular external appearance for the doorway.

9. Apparatus as claimed in claim 8, wherein the articles which depend from the mounting are shaped or positioned with respect to the mounting so that the door is openable and not obstructed by the apparatus.

10. Apparatus for attachment to a door or wall surface, said apparatus including attachment means and, on an external face thereof an area defined for writing or drawing thereon, said area having a surface which allows the application and subsequent removal of the writing or drawing applied thereto.

11. Apparatus as claimed in claim 10, wherein the area for writing or drawing is a blackboard or white board surface and the writing or drawing applied thereto is removed by suitable wiping means.

12. Apparatus as claimed in claim 10, wherein the area for applying the writing or drawing includes a series of magnetic particles located behind a front surface and the writing or drawing applied thereto can be removed by movement of a member with respect to the said surface.

13. Apparatus as claimed in claim 10, wherein the apparatus includes a number of activity indicators and a means allowing selection of one of said activities and providing a visual indication of said selection.

14. Apparatus as claimed in claim 10, wherein the apparatus has an appearance linked to a particular environment or licensed character.
